(19) United States
(12) Patent Application Publication
(10) Pub. No.: US 2005/0283588 A1
(43) Pub. Date: Dec. 22, 2005

(54) Instruction control apparatus, function unit, program conversion apparatus, and language processing apparatus

(76) Inventor: Yukihiko Yamashita, Tokyo (JP)

Correspondence Address: STAAS & HALSEY LLP, SUITE 700, 1201 NEW YORK AVENUE, N.W., WASHINGTON, DC, 20005, US

(21) Appl. No.: 11/044,631

(22) Filed: Jan. 28, 2005

Related U.S. Application Data
(63) Continuation of application No. PCT/JP02/07726, filed on Jul. 30, 2002.

(51) Int. Cl. G06F 9/30

(52) U.S. Cl. 712/217

(57) ABSTRACT

The invention relates to an instruction control apparatus, a function unit, a program conversion apparatus, and a language processing apparatus. An object of the invention is to alter and add functions to the above apparatuses inexpensively and freely. To this end, in an instruction control apparatus according to the invention creates a sequence of summation values of numbers of input operands and a sequence of summation values of the numbers of output operands, and correlates, with input operands and output operands without overlap, input registers and output registers that are lower in rank than corresponding summation values included in the sequences of summation values. Physical registers are assigned to each set of input registers and output registers.

### CROSS REFERENCE TO RELATED APPLICATION

This application is a continuation application of International Application PCT/JP02/07726, filed Jul. 30, 2002, and designating the U.S.

### BACKGROUND OF THE INVENTION

1. Field of the Invention

The present invention relates to an instruction control apparatus that decodes a sequence of machine codes on a basic block basis and plays a leading role in assigning operands to physical registers in an information processing apparatus. It also relates to a function unit that realizes the function of an instruction whose operands have been determined by the instruction control apparatus, to a program conversion apparatus and a language processing apparatus that convert an existing load module and a source program written in a prescribed assembler language, respectively, into a sequence of machine codes that is compatible with the instruction control apparatus.

2. Description of the Related Art

With the recent establishment of the technologies that realize high-speed data communication and advancement of the information society, the demand for techniques capable of processing various kinds of information such as an image efficiently or flexibly in real time has increased and processors capable of adding and altering functions without impairing the advantages of the RISC architecture have been studied and developed.

However, many of those processors (hereinafter referred to as “first conventional example”) are implemented by merely enabling the addition and alteration of functions relating to an existing ALU and hence the addition and alteration of functions are not satisfactory in the following points:
It is difficult to secure a high degree of freedom that relates to the execution latency of an instruction to be expanded.
It is difficult to permit alteration of the basic configuration or operation of a pipeline.
It is difficult to add or alter a transfer instruction or a branch instruction.
In many cases, the change of the number of operands (including immediate data) and their word lengths is not permitted because of restrictions on the alteration of machine code formats.
Many of the above processors hardly match such techniques as the superscalar, branch prediction, and out of order, and hence it is difficult to increase the processing speed even if these techniques are used.

Among the techniques that enable the addition and alteration of functions satisfactorily are the following TTAs and BISC architecture:
The TTAs (hereinafter referred to as “second conventional example”) in which each of instructions is defined for each combination of registers corresponding to operands and is realized as a combination of register transfer instructions.
The BISC architecture (hereinafter referred to as “third conventional example”) that is different from the TTAs in having instruction codes and in which an instruction system is formed as combinations of inter-register transfer instructions and immediate data representing operation codes.

However, the second conventional example cannot necessarily attain the addition and alteration of functions freely because of a limited kinds of functions.

The third conventional example can secure a higher degree of freedom of addition and alteration of functions than the second conventional example irrespective of the execution latency and enables the addition of not only a branch instruction but also a transfer instruction. However, it is difficult for the third conventional example to increase the processing speed by using the branch prediction and other techniques, and the efficiency of utilization of the memory areas of the main storage is low because redundant information is included in a machine code.

Further, in the third conventional example, the information of internal components should be saved before activation of interrupt processing, which complicates the hardware configuration and may unduly delay the activation of the interrupt processing.

### SUMMARY OF THE INVENTION

An object of the present invention is to provide an instruction control apparatus, a function unit, a program conversion apparatus, and a language processing apparatus that make it possible to alter a function of executing a desired instruction and to add an instruction to make a new function at a low cost without impairing the advantages of the RISC architecture.

Another object of the invention is to apply information processing technologies to a variety of fields without reduction in performance or cost increase.

Another object of the invention is to execute each instruction efficiently under functional distribution using function units irrespective of the number or combination of operands even in the case where the format or word length of immediate operands is not compatible with the number or word length of physical registers.

Another object of the invention is to simplify the processing relating to the instruction control than in a case that immediate operands and input operands other than the immediate operands are delivered separately to function units.

Another object of the invention is to avoid unnecessary data transfer between physical registers and to increase the responsiveness and reliability of the apparatuses of the present invention.

Another object of the invention is to efficiently deliver each output operand as an input operand of an instruction included in a common basic block or a succeeding basic block.

Another object of the invention is to perform efficient instruction control without unnecessarily complexing the processing relating to the management of the physical registers.

Still another object of the invention is to execute a variety of instructions efficiently without performance reduction irrespective of the number or combination of operands necessary for the execution of the instructions.

Another object of the invention is to heighten the speed of branching. Another object of the invention is to increase the efficiency of predecoding and instruction control as well as the total processing speed.

Another object of the invention is to add and alter a variety of functions without any changes in the basic instruction formats.

Another object of the invention is to increase the efficiency of the predecoding and instruction control.

Another object of the invention is to add and alter a variety of functions flexibly without changing the word length of the main storage or the word length of basic instructions.

Another object of the invention is to shorten the length of machine codes and simplify the structure thereof.

Another object of the invention is to make the apparatuses of the present invention adaptable to a variety of information processing apparatuses whose instruction systems have a fixed word length.

Another object of the invention is to simplify the configurations of the apparatuses of the present invention and increase the responsiveness thereof.

Yet another object of the invention is to increase the efficiency of repetitive processing.

Another object of the invention is that when a programmer employs an instruction having a particular operation code on specific purpose, after the instruction dependence relationships can be established early and efficiently as he/she has intended.

Another object of the invention is to attain functional distribution or load distribution among a plurality of function units when functions of the function units are added or altered.

Another object of the invention is to effectively use existing object programs and load modules.

A further object of the invention is to effectively use existing source programs.

The above objects are attained by the instruction control apparatus which extracts Input operands and output operands from each of basic blocks that is made up of a sequence of machine codes, and individually creates sequences of summation values of the numbers of input operands and of output operands. The instruction control apparatus then correlates without overlap input operands and output operands with virtual input registers and output registers that are in ranks lower than corresponding summation values included in the sequences of summation values. Moreover, the instruction control apparatus assigns physical registers to each of sets of output registers and input registers. The output registers are correlated with respective output operands of all of the instructions, and the input registers are correlated with input operands which are to be delivered to the function units as respective input operands.

This instruction control apparatus can deliver every machine code included in each basic block and including no identifiers of operands, to a function unit having a function of executing the machine code or to a cache memory upstream of the function unit with the basic block. Further, it can make efficient code deliveries in parallel under the functional distribution of the function units as long as the virtual input registers and output registers and the physical registers are managed in a manner suitable for the sequence of machine codes.

The above objects are attained by the instruction control apparatus which does not count a number of immediate operands for a number of input operands included in each summation value and delivers the not-counted immediate operands to the function units.

This instruction control apparatus can deliver immediate operands to the function units without intervention of physical registers.

The above objects are attained by the instruction control apparatus which individually generates summation values of numbers of immediate operands and of other input operands for each basic block. It assigns physical registers to the immediate operands and the other input operands to store the immediate operands in the respective physical registers assigned thereto.

This instruction control apparatus delivers all input operands via the physical registers to a function unit corresponding to each instruction included in each basic block.

The above objects are attained by the instruction control apparatus which maintains existing correlations of input registers and output registers with operands of instructions included in an immediately preceding basic block among the operands included in the sequences of input operands and of the output operands.

This instruction control apparatus delivers operands that have been determined in any of the basic blocks and stored in any physical register, via the same physical register to function units corresponding to individual instructions included in a basic block succeeding the basic block concerned.

The above objects are attained by the instruction control apparatus which correlates particular ones of the physical registers in advance with an output operand of each instruction included in the basic blocks, and preferentially assigns certain physical registers of the particular physical registers to an output register that is correlated with an output operand of each instruction included in each of the sets and to an input register which is to be given the output operand. The certain physical registers are correlated in advance with the output operand.

This instruction control apparatus uniquely determines physical registers as ones that comply with the order of the instructions in each basic block when they are used for storing the output operand of an instruction included in any of the basic blocks and delivering the output operand to a function unit corresponding to other instruction included in the same basic block.

The above objects are attained by the instruction control apparatus which maintains existing assignments of physical registers to input operands having no dependence relationships within the basic blocks among the input operands of the instructions included in the basic blocks.

This instruction control apparatus efficiently delivers output operands of instructions included in a preceding basic block to a single or a plurality of succeeding basic block(s) without being transferred to other physical registers or copied, as long as they correspond to input operands of instructions included in the succeeding basic block(s).

The above objects are attained by the instruction control apparatus which stores, in a cache memory that corresponds to a function unit, a record including an operation code of an instruction and reference addresses of input registers and of an output register that are correlated with input operands and an output operand of the instruction, respectively. The instruction control apparatus assigns physical registers to each set of input registers and output registers that are uniquely determined by reference addresses included in most previous records stored in the cache memories and that are correlated with input operands and output operands of such a number as to be necessary for execution of instructions corresponding to the most previous records.

This instruction control apparatus distributes all machine codes included in each basic block to cache memories corresponding to function units having functions of executing these machine codes without using no identifiers of operands, to execute the machine codes in parallel under functional distribution of the function units.

The above objects are attained by the instruction control apparatus which includes branch destination tables for storing therein cache addresses and addresses of storage areas of main storage for each basic block. The cash addresses designate storage areas storing therein respective instructions with operation codes that are stored first in the cash memories. The storage areas of main storage individually stores therein the instructions with the first stored operation codes. The instruction control apparatus updates read pointers of the cache memories to a cache address that is stored in the branch destination tables in association with an address indicating a branch destination, when a particular one of the function units performs a valid branch.

This instruction control apparatus, as long as all the instructions of a basic block corresponding to a branch destination are sorted and stored in the cache memories, can perform a branch to the branch destination by updating the read pointers of the cache memories.

The above objects are attained by the instruction control apparatus in which each of the basic blocks is a sequence of words that can be included in the sequence of machine codes, and it is composed of a sequence of machine codes formed by packing all or part of operation codes, input operands, and output operands of instructions included in the sequence of machine codes.

According to this instruction control apparatus, it is able to simplify the processing for distributing the individual instructions included in each basic block to their corresponding function units or the cache memories corresponding to the function units, compared with a case that the operation codes, the input operands, and the output operands are not packed.

The above objects are attained by the instruction control apparatus in which a particular instruction that can be included in the sequence of machine codes includes an operation code as an immediate operand and is formed by replacing the operation code with a combination of numbers of input operands and output operands.

According to this instruction control apparatus, even in the case where the number and combinations of functions realized via a function unit corresponding to the above-mentioned particular instruction is too large to be expressed in the word length of a field where an operation code is originally accommodated, it is able to add or alter a desired function as long as an operation code as an immediate operand given to the function unit and a combination of numbers of input operands and output operands given thereto instead of the original operation code are identifiable.

The above objects are attained by the instruction control apparatus in which the operation codes are packed with identifiers of their respective function units or information signifying coincidence/non-coincidence between the function units and previously used function units.

According to this instruction control apparatus, even in the case where all operation codes packed in each basic block are given, they can be simply sorted, according to the above information, for distribution to the respective function units.

The above objects are attained by the instruction control apparatus in which the operation codes are words whose values can be identical, when they correspond to different function units.

According to this instruction control apparatus, it is possible not to make a change in the word length of machine codes to be stored in the main storage even if the number and combinations of functions to be executed by any function unit are large.

The above objects are attained by the instruction control apparatus in which all or part of an operation code, an input operand, and an output operand of a branch instruction are included in each of the basic blocks, being packed at its head or tail of the basic block.

According to this instruction control apparatus, any basic block is given a sequence of arithmetic instructions and a sequence of transfer instructions both not including a branch instruction so that it is able to efficiently discriminate the branch instruction from the arithmetic instructions and the transfer instructions by an easily identifiable delimiter having a short word length and located at the boundary between the two kinds of instructions, as long as a branch instruction is located at a predetermined position in the basic block and distributed to a corresponding function unit.

The above objects are attained by the instruction control apparatus in which each of the basic blocks is a sequence of words having a constant word length.

According to this instruction control apparatus, the aforementioned instruction control can be made with no basic change in the word length of the main storage or the instruction format.

The above objects are attained by the instruction control apparatus in which part of the physical registers is/are general-purpose register(s).

According to this instruction control apparatus, it is possible to deliver among the basic blocks input operands stored in the general-purpose registers and output operands to be held by the general-purpose registers without transferring them to physical registers.

The above objects are attained by the function unit which temporarily stores Instructions in a cache memory and stores in the cache memory an executable instruction thereof and a basic block number to which the executable instruction belong, and fixes the basic block number in repeatedly executing the basic block.

This function unit can repeatedly execute a sequence of instructions included in any basic block in order in which the instructions were executable in a preceding execution process.

The above objects are attained by the function unit including a scheduler which preferentially selects an instruction having a particular operation code from executable instructions.

When a sequence of instructions stored in the cache memory and included in a basic block to be subsequently executed contains an instruction having a particular operation code, this function unit preferentially executes the instruction having the particular operation code over instructions included in a preceding basic block as soon as it acquires all operands necessary for the execution.

Part of the above objects are attained by the function unit which selects an instruction having a particular operation code when given an immediate operand of the instruction or information having a prescribed correlation with the immediate operand from exterior, or having successfully delivered the immediate operand or the information to the exterior.

This function unit operates in synchronism with other function units or devices that share a function or a load relating to the execution of the instruction having a particular operation code, by exchanging the above information with the other function units or devices.

The above objects are attained by the program conversion apparatus which divides a sequence of machine codes into a sequence of basic blocks, and extracts, from each of the basic blocks, input operands, output operands, and operation codes of all instructions included therein. Then, the program conversion apparatus sorts the extracted operation codes of each basic block into groups of operation codes in order for respective function units to perform processing suitable for the groups of operation codes. The program conversion apparatus converts the sequence of machine codes into sequences of words in a form suitable for an instruction control. The sequence of machine codes is such that the input operands, the output operands, and the operation codes are packed in order of the function units in each basic block.

This program conversion apparatus can execute existing machine codes or machine codes in a desired form under the instruction control according to the invention even if a source program corresponding to the machine codes is not re-assembled.

The above objects are attained by the language processing apparatus which divides a sequence of instructions written in an assembler language into sequences of basic blocks, and extracts, from each basic block, identifiers of input operands and output operands of all instructions included therein as well as mnemonic codes of the instructions. Then, the language processing apparatus sorts the extracted mnemonic codes of each basic block into groups of mnemonic codes in order for respective function units to perform processing suitable for the groups. The language processing apparatus converts the sequence of instructions into sequences of machine codes in a form suitable for an instruction control. The sequence of machine codes are such that the input operands and output operands corresponding to the identifiers extracted and corresponding to the respective mnemonic codes are packed in each basic block in order of the function units.

This language processing apparatus can directly convert an existing source program written in an assembler language or a source program written in a desired assembler language into a sequence of machine codes that are executable under the instruction control according to the invention, even if the source program is not assembled by an assembler that is inherently suitable therefor.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing the principles of operation of instruction control apparatus according to the present invention;

FIG. 2 is a block diagram showing the principles of operation of function units according to the invention;

FIG. 3 is a block diagram showing the principle of operation of a program conversion apparatus according to the invention;

FIG. 4 is a block diagram showing the principle of operation of a language processing apparatus according to the invention;

FIG. 5 shows first to fifth embodiments of the invention;

FIGS. 6A-6C illustrate the operation of the first embodiment of the invention;

FIG. 7 illustrates the operation of the first embodiment of the invention;

FIG. 8 illustrates the operation of the first embodiment of the invention;

FIG. 9 shows a detailed structure of a register management section;

FIG. 10 shows the structure of a PB table;

FIG. 11 illustrates the operation of the fourth embodiment of the invention; and

FIG. 12 is a flowchart showing the operation of a sixth embodiment of the invention.

### DESCRIPTION OF THE PREFERRED EMBODIMENTS

First, the principles of operation of instruction control apparatus according to the present invention will be described.

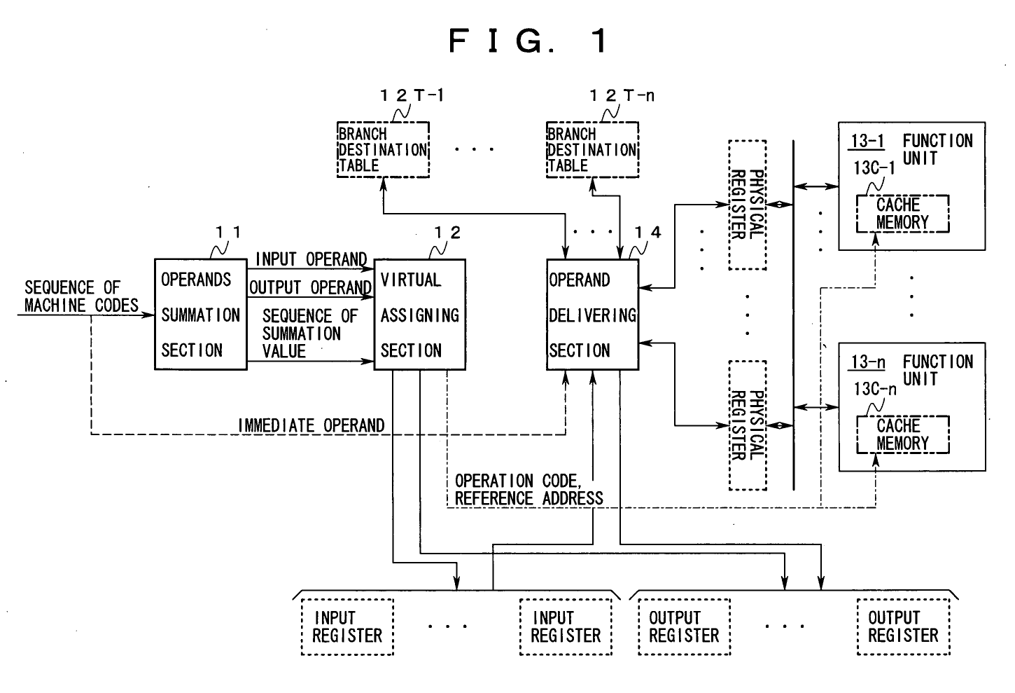

FIG. 1 is a block diagram showing the principles of operation of the instruction control apparatus according to the invention. The instruction control apparatus shown in FIG. 1 are composed of all or part of an operands summation section 11, a virtual assigning section 12, branch destination tables 12T-1 to 12T-n, function units 13-1 to 13-n, cache memories 13C-1 to 13C-n, and an operand delivering section 14.

The principle of operation of a first instruction control apparatus according to the invention is as follows.

The operands summation section 11 extracts the input operands and output operands of all the instructions included in each of basic blocks that is a sequence of machine codes, and separately creates a sequence of summation values of the numbers of input operands and a sequence of summation values of the numbers of output operands. The virtual assigning section 12 manages virtual input registers and output registers whose assignment should be updated for each basic block, and correlates, with input operands and output operands, without overlap, input registers and output registers that are lower in rank than individual summation values included in the sequences of summation values. The operand delivering section 14 manages physical registers to be used for information delivery to and from the function units 13-1 to 13-n having functions corresponding to instructions that may be included in the basic blocks, and assigns physical registers to each set produced from output registers that are correlated with the respective output operands of all the instructions and input registers to which the respective input operands of all the instructions should be delivered and that are correlated with the respective input operands.

According to this instruction control apparatus, every machine code included in each basic block can be delivered to a function unit having a function that enables execution of the machine code or a cache memory upstream of the function unit without using any identifiers of operands. Further, the management of the virtual input registers and output registers and the physical registers can be performed parallel efficiently under functional distribution using the function units as long as it is performed in such a form as to match the sequence of machine codes.

All the input operands and all the output operands of all the machine codes included in each basic block are temporarily correlated with virtual input registers and output registers and then assigned to physical registers in such a form that dependence relationships both within the basic block concerned and with other basic blocks are eliminated, as long as the management of the virtual input registers and output registers and the physical registers is performed in such a form as to match the sequence of machine codes.

Further, individual machine codes that may be included in each basic block can be added and altered flexibly in connection with a variety of functions without alteration of a basic hardware configuration that realizes an instruction control irrespective of the number or combination of operands as long as function units corresponding to the respective machine codes are provided and the machine codes are given in such a form as to enable identification of the function units.

Therefore, application of information processing technologies to a variety of fields is enabled without performance reduction or cost increase though the configuration is standardized.

The principle of operation of a second instruction control apparatus according to the invention is as follows.

The operands summation section 11 does not count the number of immediate operands for the number of input operands constituting each summation value. The operand delivering section 14 delivers immediate operands whose numbers were not counted by the operands summation section 11 to the function units 13-1 to 13-n.

According to this instruction control apparatus, immediate operands can be delivered to the function units 13-1 to 13-n without intervention of physical registers.

Therefore, each instruction can be executed efficiently under functional distribution using the function units 13-1 to 13-n irrespective of the number or combination of operands even in the case where the format or word length of immediate operands does not match the number or word length of physical registers.

The principle of operation of a third instruction control apparatus according to the invention is as follows.

The operands summation section 11 separately creates a sequence of summation values of the numbers of immediate operands and a sequence of summation values of the numbers of other input operands for each basic block among the input operands. The operand delivering section 14 separately assigns physical registers to the immediate operands and the other input operands, and stores the immediate operands in the respective physical registers assigned thereto.

According to this instruction control apparatus, all input operands are delivered, via physical registers, to a function unit corresponding to each instruction included in each basic block.

Therefore, the processing relating to the instruction control is made simpler than in a case that immediate operands and input operands other than the immediate operands are delivered separately to the function units.

The principle of operation of a fourth instruction control apparatus according to the invention is as follows.

The virtual assigning section 12 maintains existing correlation of input registers and output registers with the same operands as included in instructions that are included in an immediately preceding basic block among the operands included in the sequence of the input operands and the sequence of the output operands.

According to this instruction control apparatus, operands that have been determined in one basic block and stored in physical registers are delivered, via the same physical registers, to function units corresponding to individual instructions included in the basic block ensuing the basic block concerned.

Therefore, useless data transfer between physical registers can be avoided and the response speed and the reliability can be increased.

The principle of operation of a fifth instruction control apparatus according to the invention is as follows.

Particular ones of the physical registers are correlated in advance with the output operand of each instruction included in the basic block concerned. The operand delivering section 14 assigns, with higher priority, to an output register that is correlated with the output operand of an individual instruction included in each set and an input register to which the output operand should be delivered, particular physical registers that are correlated in advance with the output operand among the particular physical registers.

According to this instruction control apparatus, physical registers to be used for storing the output operand of an instruction included in every basic block and for delivering the output operand to a function unit corresponding to other instruction included in the same basic block are uniquely set to physical registers that comply with the order of the instructions in the basic block.

Therefore, the above-mentioned output operand can be delivered efficiently as an input operand of an instruction included in the common basic block or the ensuing basic block.

The principle of operation of a sixth instruction control apparatus according to the invention is as follows.

The operand delivering section 14 maintains assignment of existing physical registers to input operands having no dependence relationships within the basic block concerned among the input operands of the instructions included in the basic block concerned.

According to this instruction control apparatus, output operands of instructions included in the basic block concerned are efficiently delivered to one or a plurality of ensuing basic blocks without being transferred or copied to other physical registers as long as they correspond to input operands of instructions included in the one or plurality of ensuing basic blocks.

Therefore, the processing relating to the management of the physical registers is not complicated unduly and the instruction control is performed efficiently.

The principle of operation of a seventh instruction control apparatus according to the invention is as follows.

The virtual assigning section 12 stores, in a cache memory that corresponds to a function unit having a function corresponding to each instruction included in the basic block concerned among the function units 13-1 to 13-n, a record consisting of an operation code of the instruction and reference addresses of input registers and an output register that are correlated with input operands and an output operand of the instruction, respectively. The operand delivering section 14 assigns physical registers to each set of input registers and output registers that are uniquely determined from reference addresses included in first records stored in the cache memories 13C-1 to 13C-n corresponding to the function units 13-1 to 13-n and that are correlated with input operands and output operands of such a number as to be necessary for execution of instructions corresponding to those records.

According to this instruction control apparatus, all machine codes included in each basic block are distributed to cache memories corresponding to function units having functions that enable execution of those machine codes without using no identifiers of operands and are executed parallel under functional distribution using those function units.

Therefore, as long as function units and caches corresponding to individual instructions are provided, a variety of instructions can be executed efficiently without performance reduction irrespective of the number and combination of operands necessary for the execution of those instructions.

The principle of operation of an eighth instruction control apparatus according to the invention is as follows.

Cache addresses indicating storage areas where instructions having operation codes that were stored first in the cache memories 13C-1 to 13C-n are stored and addresses of storage areas where the respective instructions are stored among storage areas of main storage are stored in the branch destination tables 12T-1 to 12T-n for each of the basic blocks. The operand delivering section 14 updates read pointers of the cache memories 13C-1 to 13C-n to cache addresses that are stored in the branch destination tables 12T-1 to 12T-n as corresponding to an address indicating a branch destination when a particular function unit among the function units 13-1 to 13-n makes a valid branch.

According to this instruction control apparatus, as long as all the instructions of a basic block corresponding to a branch destination are stored in the cache memories 13C-1 to 13C-n in a classified manner, a branch to the branch destination is attained by updating the read pointers of the cache memories 13C-1 to 13C-n.

Therefore, branching can be performed faster than in a case that the instructions of a basic block corresponding to a branch destination should be read again from the main storage and distributed to and stored in the cache memories 13C-1 to 13C-n when it has been determined that a branch should be caused effectively.

The principle of operation of a ninth instruction control apparatus according to the invention is as follows.

Each of the basic blocks is sequences of words that correspond to respective function units having functions corresponding to instructions that may be included in the sequence of machine codes and that are separately packed with all or part of operation codes, input operands, and output operands of instructions included in the sequence of machine codes.

According to this instruction control apparatus, the procedure of processing that should be performed to distribute the individual instructions included in each basic block to the corresponding function units or the cache memories corresponding to those function units can be made simpler than in a case that the operation codes, the input operands, and the output operands are not packed separately.

Therefore, the efficiency of the predecoding and instruction control can be increased and the total processing speed can be increased.

The principle of operation of a 10th instruction control apparatus according to the invention is as follows.

A particular instruction that may be included in the sequence of machine codes includes an operation code in the form of an immediate operand and has a combination of the numbers of input operands and output operands instead of an original operation code.

According to this instruction control apparatus, even in the case where the number and the number of combinations of functions that should be attained via a function unit common to a particular instruction is too large to be expressed by the word length of a field where an operation code should be accommodated originally, a desired function can be added or altered as long as an operation code in which the function unit is given as an immediate operand and a combination of the numbers of input operands and output operands that are given instead of the original operation code can be identified.

Therefore, a variety of functions can be added and altered flexibly without any changes in the basic instruction system.

The principle of operation of an 11th instruction control apparatus according to the invention is as follows.

The operation codes are packed with identifiers of corresponding function units or information meaning coincidence/non-coincidence between to the function units and previously used function units.

According to this instruction control apparatus, even in the case where all operation codes are given being packed for each basic block, they are sorted simply on the basis of the above information and distributed to the corresponding function units.

Therefore, the efficiency of the predecoding and instruction control can be increased.

The principle of operation of a 12th instruction control apparatus according to the invention is as follows.

The operation codes are words whose values can be identical when the operation codes correspond to different function units.

According to this instruction control apparatus, a change in the word length of machine codes to be stored in the main storage can be avoided even if the number and the number of combinations of functions to be attained by one function unit are large.

Therefore, a variety of functions can be added and altered flexibly without changing the word length of the main storage or the word length of basic instructions.

The principle of operation of a 13th instruction control apparatus according to the invention is as follows.

All or part of an operation code, input operands, and an output operand of a branch instruction included in each of the basic blocks are packed at the head or tail of the basic block.

According to this instruction control apparatus, in each basic block a sequence of arithmetic instructions and a sequence of transfer instructions are given as sequences of instructions that do not include a branch instruction. Therefore, as long as a branch instruction is identified on the basis of a predetermined position in the basic block concerned and distributed to a corresponding function unit, the branch instruction can be discriminated from the arithmetic instructions and the transfer instruction on the basis of a delimiter that is located at the boundary between the two kinds of instructions and has a short word length and hence can be identified easily.

Therefore, machine codes to be stored in the main storage for each basic block can be shortened and simplified in structure.

The principle of operation of a 14th instruction control apparatus according to the invention is as follows.

Each of the basic blocks is a sequence of words having a constant word length.

According to this instruction control apparatus, the instruction control can be performed with no basic change in the word length of the main storage or the instruction formats.

This enables flexible application of the invention to a variety of information processing apparatus whose instruction system has a fixed word length.

The principle of operation of a 15th instruction control apparatus according to the invention is as follows.

Part of the physical registers are general-purpose registers.

According to this instruction control apparatus, input operands stored in the general-purpose registers and output operands to be held by the general-purpose registers are both delivered from the basic block concerned to another basic block and vice versa without being transferred uselessly to or from physical registers.

Therefore, the configuration can be simplified and the response speed can be increased.

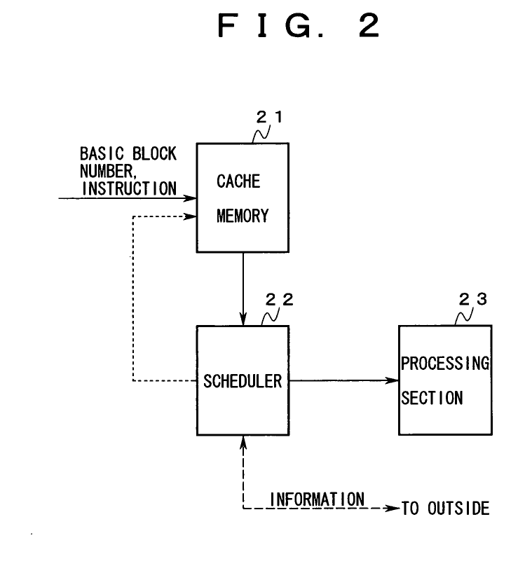

FIG. 2 is a block diagram showing the principles of operation of function units according to the invention. The function units shown in FIG. 2 are composed of a cache memory 21, a scheduler 22, and a processing section 23.

The principle of operation of a first function unit according to the invention is as follows.

The scheduler 22 selects an executable instruction that is stored in the cache memory 21 together with a basic block number that should be executed under an instruction control among instructions each of which includes an operation code and operands indicated as identifiers of virtual registers and that are stored in the cache memory 21 together with basic block numbers that are identified under an instruction prefetch scheme. The processing section 23 acquires, from the cache memory 21, the instruction selected by the scheduler 22 and performs processing suitable for an operation code of the instruction while converting identifiers indicating operands of the instruction to physical registers under the instruction control. The scheduler 22 sequentially stores, in the cache memory 21, the selected instruction and the basic block number to which the selected instruction belong among the instructions stored in the cache memory 21, and fixes the basic block number when repeatedly executing the basic block.

According to this function unit, for example, for the sequence of instructions belonging to any basic block, the order of repetitive execution is set the same as order in which the execution of instructions was enabled actually in a preceding execution process or higher priority is given to order of operations whose results can be used immediately than to order of operations whose results cannot be used immediately.

Therefore, the efficiency of repetitive processing can be increased.

The principle of operation of a second function unit according to the invention is as follows.

The scheduler 22 selects an executable instruction that is stored in the cache memory 21 together with a basic block number that should be executed under an instruction control among instructions each of which includes an operation code and operands indicated as identifiers of virtual registers and that are stored in the cache memory 21 together with basic block numbers that are identified under an instruction prefetch scheme. The processing section 23 acquires, from the cache memory 21, the instruction selected by the scheduler 22 and performs processing that is suitable for an operation code of the instruction while converting identifiers indicating operands of the instruction to physical registers under the instruction control. The scheduler 22 selects, with higher priority, an instruction having a particular operation code from executable instructions.

According to this function unit, if an instruction having a particular operation code is included in the sequence of instructions of a basic block that is stored in the cache memory 21 and should be executed subsequently, the instruction having the particular operation code is executed with higher priority than the instructions included in the basic block concerned as soon as all operands necessary for its execution are acquired.

Therefore, dependence relationships after the instruction having the particular operation code can be assured early and efficiently in a manner intended by a programmer who employed this instruction.

The principle of operation of a third function unit according to the invention is as follows.

The scheduler 22 selects an executable instruction that is stored in the cache memory 21 together with a basic block number that should be executed under an instruction control among instructions each of which includes an operation code and operands indicated as identifiers of virtual registers and that are stored in the cache memory 21 together with numbers of basic blocks that are identified under an instruction prefetch scheme. The processing section 23 acquires, from the cache memory 21, the instruction selected by the scheduler 22 and performs processing that is suitable for an operation code of the instruction while converting identifiers indicating operands of the instruction to physical registers under the instruction control. The scheduler 22 selects an instruction having a particular operation code from the instructions stored in said cache memory 21 when an immediate operand of the instruction or information having a prescribed correlation with the immediate operand is given from the outside or delivered successfully to the outside.

Because of the exchange of information of the above kind, this function unit operates in synchronism with another function unit or device that shares a function or load relating to the execution of an instruction having a particular operation code.

Therefore, a plurality of function units can make functional distribution or load distribution in accordance with addition or alteration of a function freely.

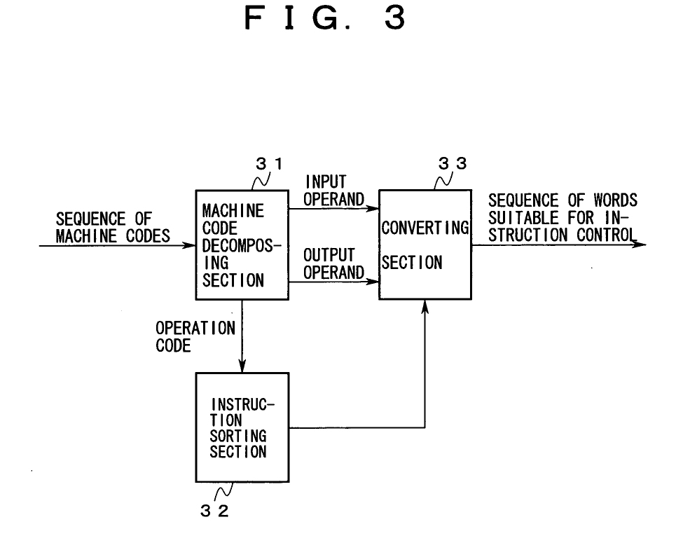

FIG. 3 is a block diagram showing the principle of operation of a program conversion apparatus according to the invention. The program conversion apparatus shown in FIG. 3 is composed of a machine code decomposing section 31, an instruction sorting section 32, and a converting section 33.

The principle of operation of the program conversion apparatus according to the invention is as follows.

The machine code decomposing section 31 splits a sequence of machine codes into a sequence of basic blocks and extracts, from each of the basic blocks, the input operands and output operands of all the instructions included in the basic block and the operation codes of the instructions. The instruction sorting section 32 sorts the operation codes of each basic block that have been extracted by the machine code decomposing section 31 into groups of operation codes that correspond to function units for performing processing suitable for the groups of operation codes, respectively. The converting section 33 converts the sequence of machine codes to sequences of words in which the input operands and output operands extracted by the machine code decomposing section 31 and the operation codes obtained by sorting by the instruction sorting section 32 are packed in order of the function units for each basic block and that are in a format suitable for an instruction control.

According to this program conversion apparatus, existing machine codes or machine codes having a desired format can be executed under the instruction control according to the invention even if a source program corresponding to the machine codes is not assembled again.

Therefore, existing object programs and load modules can be used effectively.

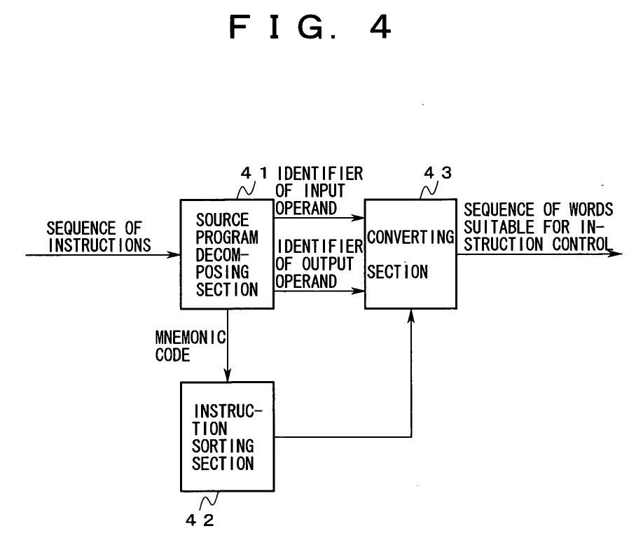

FIG. 4 is a block diagram showing the principle of operation of a language processing apparatus according to the invention. The language processing apparatus shown in FIG. 4 is composed of a source program decomposing section 41, an instruction sorting section 42, and a converting section 43.

The principle of operation of the language processing apparatus according to the invention is as follows.

The source program decomposing section 41 splits a sequence of instructions that are written in an assembler language and are not assembler instructions into a sequence of basic blocks and extracts, from each of the basic blocks, identifiers of the input operands and output operands of all the instructions included in the basic block and mnemonic codes of the instructions. The instruction sorting section 42 sorts the mnemonic codes of each basic block that have been extracted by the source program decomposing section 41 into groups of mnemonic codes that correspond to function units for performing processing suitable for the groups of mnemonic codes, respectively. The converting section 43 converts the sequence of instructions to sequences of machine codes in which the input operands and output operands corresponding to the respective identifiers extracted by the source program decomposing section 41 and operation codes corresponding to the respective mnemonic codes obtained by sorting by the instruction sorting section are packed in order of the function units for each basic block and that are in a format suitable for an instruction control on the sequence of instructions.

According to this language processing apparatus, an existing source program written in an assembler language or a source program written in a desired assembler language can be converted directly into a sequence of machine codes that can be executed under the instruction control according to the invention even if the source program is not assembled by an assembler that is suitable for it inherently.

Therefore, existing source programs can be used effectively.

Embodiments of the invention will be hereinafter described in detail with reference to the drawings.

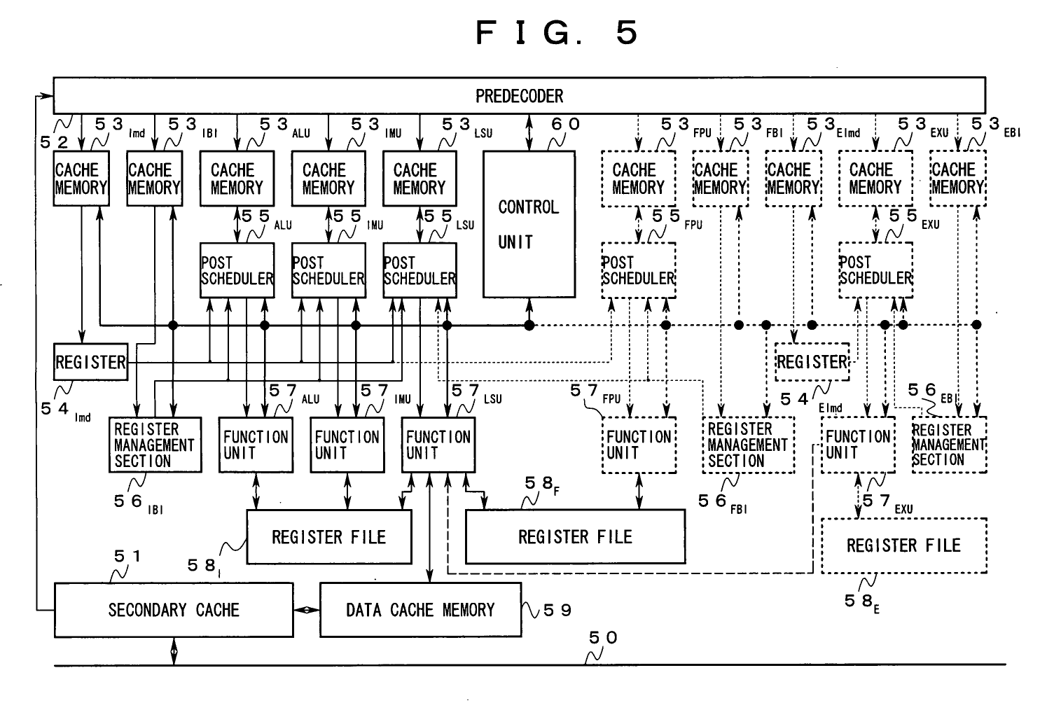

FIG. 5 shows first to fifth embodiments of the invention. As shown in FIG. 5, a secondary cache memory (hereinafter referred to as “secondary cache”) 51 is connected to an external bus 50 and the read port of the secondary cache 51 is connected to the input of a predecoder 52. First to 10th outputs of the predecoder 52 are connected to first inputs of cache memories (hereinafter referred to merely as “caches”) 53_{Imd}, 53_{IBI}, 53_{ALU}, 53_{IMU}, 53_{LSU}, 53_{FPU}, 53_{FBI}, 53_{EImd}, 53_{EXU}, and 53_{EBI}, and the input/output port of the predecoder 52 is connected to a corresponding port of a control unit 60. The outputs of the caches 53_{Imd} and 53_{EImd} are connected to the inputs of registers 54_{Imd} and 54_{EImd}, respectively, and post schedulers 55_{ALU}, 55_{IMU}, 55_{LSU}, 55_{FPU}, and 55_{EXU} are cascade-connected to the caches 53_{ALU}, 53_{IMU}, 53_{LSU}, 53_{FPU}, and 53_{EXU}, respectively. The output of the register 54_{Imd} is connected to first inputs of the 55_{ALU}, 55_{IMU}, 55_{LSU}, and 55_{FPU}, and the output of the register 54_{EImd} is connected to a first input of the post scheduler 55_{EImd}. The outputs of the caches 53_{IBI}, 53_{FBI}, and 53_{EBI} are connected corresponding input ports of register management sections 56_{IBI}, 56_{FBI}, and 56_{EBI}, respectively, and the output port of the register management section 56_{IBI} is connected to second inputs of the post schedulers 55_{ALU}, 55_{IMU}, and 55_{LSU}. The output of the register management section 56_{FBI} is connected to second inputs of the post schedulers 55_{LSU} and 55_{FPU}, and the output of the register management section 56_{EBI} is connected to a second input of the post scheduler 55_{EXU}. The outputs of the post schedulers 55_{ALU}, 55_{IMU}, 55_{LSU}, 55_{FPU}, and 55_{EXU} are connected to the inputs of function units 57_{ALU}, 57_{IMU}, 57_{LSU}, 57_{FPU}, and 57_{EXU}, respectively. The operand terminals of the function units 57_{ALU} and 57_{IMU} and a first operand terminal of the function unit 57_{LSU} are connected to corresponding input/output terminals of a register file 58_{I}, and a second operand terminal of the function unit 57_{LSU} and the operand terminal of the function unit 57_{FPU} are connected to corresponding input/output terminals of a register file 58_{F}. The operand terminal of the function unit 57_{EXU} is connected to a corresponding input/output terminal of a register file 58_{E}, and the sync output of the function unit 57_{EXU} is connected to the sync input of the function unit 57_{LSU}. A third operand terminal of the function unit 57_{LSU} is connected to one port of a data cache memory 59, and the other port of the data cache memory 59 is connected to a corresponding port of the secondary cache 51.

The suffixes “Imd,” “IBI,” “ALU,” “IMU,” “LSU,” “FPU,” “FBI,” “EImd,” “EXU,” and “EBI” mean “integer immediate data,” “integer-system bus instruction,” “arithmetic logic unit,” “integer misc unit,” “load store unit,” “floating point processing unit,” “floating-point-system bus instruction,” “extended immediate data,” “extended arithmetic unit,” and “extension-system bus instruction, respectively. For the sake of simplicity, the term “bus instruction” will be described later.

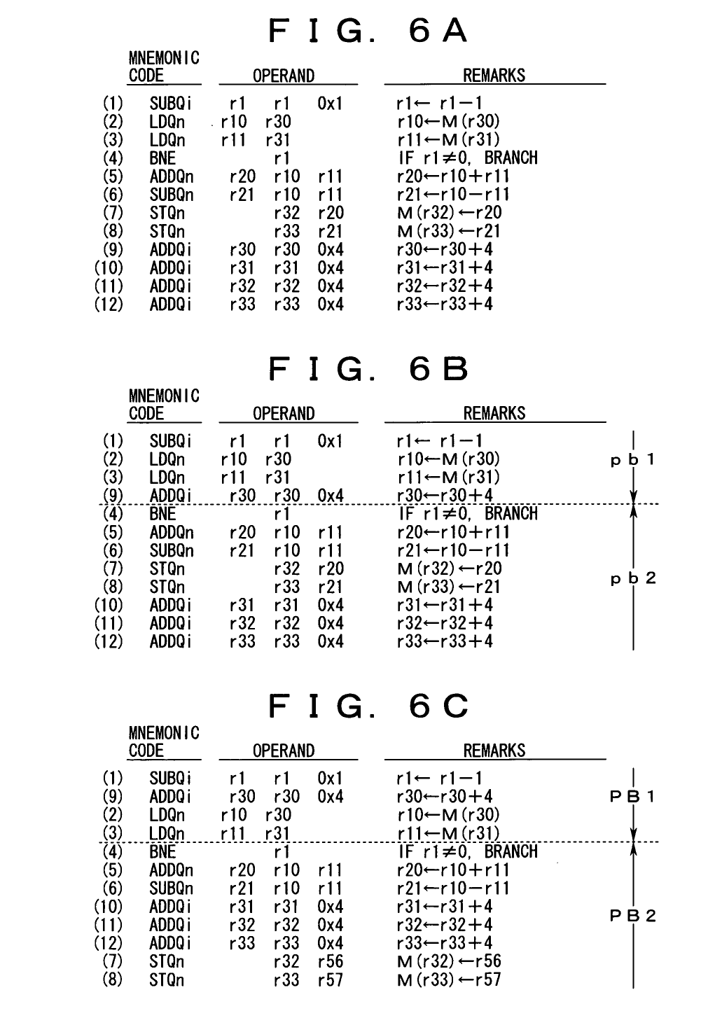

FIGS. 6A-6C, 7, and 8 illustrate the operation of the first embodiment of the invention.

### Embodiment 1

The operation of the first embodiment of the invention will be described below with reference to FIGS. 5-8.

Machine codes that were generated in advance by a prescribed language processor and are stored in a prescribed storage area of the main storage (not shown) are sequentially stored in the secondary cache 51 via the external bus 50. The language processor is not limited to an assembler and may be either of a compiler (including a linker and a locator) that directly generates a sequence of machine codes as a load module and a program conversion system that performs prescribed conversion processing on a load module that is executable by a processor (need not be a RISC processor).

For example, where a source code corresponding to the sequence of machine codes is a sequence of instructions that are listed in FIG. 6A (items (1)-(12)), as shown in FIG. 6B the sequence of machine codes is split into program blocks pb1 and pb2 that are compatible with general RISC processors. However, in this embodiment, as shown in FIG. 6C, the sequence of machine codes is given as permutations (hereinafter referred to as “collective machine code sequences”; to clarify the corresponding relationship with the corresponding program blocks, they are given identifiers PB1 and PB2 that are common to the respective program blocks) corresponding to program blocks PB1 and PB2 that are different from the program blocks pb1 and pb2 in the following points:
If a branch instruction is included in a program block, it is located at the head of the program block.
Transfer instructions are located at the tail collectively.
Arithmetic instructions are located between the branch instruction and the transfer instructions.

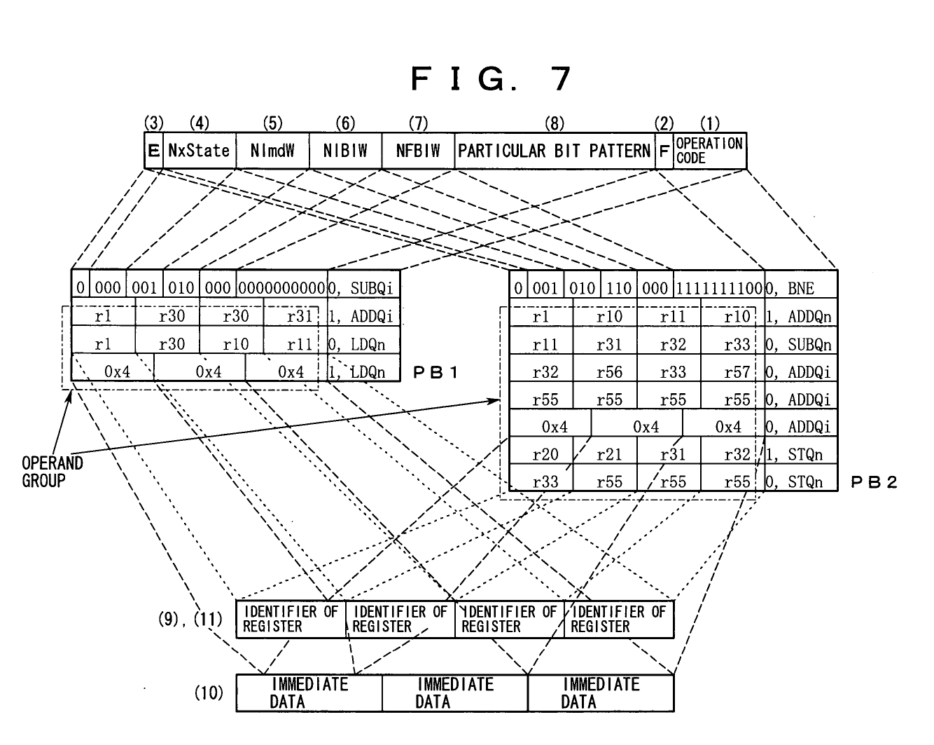

As shown in FIG. 7, each of the collective machine code sequences PB1 and PB2 is formed in the following manner:
(1) It is formed as a sequence of words having a constant word length (for the sake of simplicity, the word length is assumed here to be 32 bits).

(2) An operation code corresponding to its machine code mnemonic code is located at the lowest 7 bits of every word (indicated by symbol (1) in FIG. 7; in FIG. 7, mnemonic codes are used to clarify the corresponding relationship with the machine codes shown in FIG. 6C).

(3) A single-bit separator F whose logical value is set at “1” only if the 7-bit operation code is of a first arithmetic instruction or transfer instruction of the collective machine code sequence to which the word concerned belongs is located at the 1 bit that is adjacent to the highest bit of the 7 bits (indicated by symbol (2) in FIG. 7).

(4) The following pieces of information (hereinafter referred to as “control information”) are located at the highest 24 (=32−7−0.1) bits of the head word so as to be packed in order from the MSB:

4-1) A spare bit E (for the sake of simplicity, it is assumed here that its logical value is always set at “0”) that is used for alteration or expansion of the structure of the collective machine code sequence to which the word concerned belongs (indicated by symbol (3) in FIG. 7).

4-2) A form NxState of processing (e.g., one of no branch, a conditional branch, an unconditional branch, an unconditional branch to a subroutine, a return from a subroutine, etc.) that should be performed after execution of the collective machine code sequence to which the word concerned belongs (indicated by symbol (4) in FIG. 7).

4-3) The number NImdW of words of immediate data that are included as operands in the collective machine code sequence to which the word concerned belongs (indicated by symbol (5) in FIG. 7).

4-4) The number NIBIW of words of integer-system bus instructions that are included in the collective machine code sequence to which the word concerned belongs (indicated by symbol (6) in FIG. 7).

4-5) The number NFBIW of words of floating-point-system bus instructions that are included in the collective machine code sequence to which the word concerned belongs (indicated by symbol (7) in FIG. 7).

4-6) A particular bit pattern meaning that the word concerned is the head word of the collective machine code sequence corresponding to the program block (indicated by symbol (8) in FIG. 7).

(5) The following operands (hereinafter referred to as “operand group”) are packed in the highest 24 (32−7−1) bits of all the words following the head word in order from the MSB (surplus fields are packed with predetermined dummy words).

5-1) A sequence of 6-bit identifiers (6=log₂64) indicating general-purpose registers (for the sake of simplicity, it is assumed here that each of those registers is one of 64 registers) corresponding to input operands of the sequence of the branch instruction, arithmetic instructions, and transfer instructions (hereinafter referred to as “included instruction sequence”) that are arranged in order from the head in the collective machine code sequence concerned (indicated by symbol (9) in FIG. 7).

As shown in FIG. 7, if an identifier indicating an input operand is identical to an output operand of one of certain instructions included in the same collective machine code sequence is an identifier of 56th (56=64−8; the number 56 is determined uniquely for a maximum number (8) of instructions that can be included in each collective machine code sequence) to 64th general-purpose registers (hereinafter referred to as “particular general-purpose registers”) that are correlated with those respective instructions in order among the above-mentioned 64 general-purpose registers.

5-2) A sequence of values (for the sake of simplicity, they are assumed here to be only 8-bit integers) of immediate data (hereinafter referred to as “immediate operands”) corresponding to input operands of the included instruction sequence (indicated by symbol (10) in FIG. 7).

5-3) A sequence of 6-bit identifiers (6=log₂64) indicating general-purpose registers (for the sake of simplicity, they are assumed here to be a set of registers selected from 64 registers) corresponding to the output operands of the included instruction sequence (indicated by symbol (11) in FIG. 7).

In the following description, a sequence of identifiers of general-purpose registers that are part of an operand group and correspond to input operands or output operands will be referred to simply as “bus instructions.”

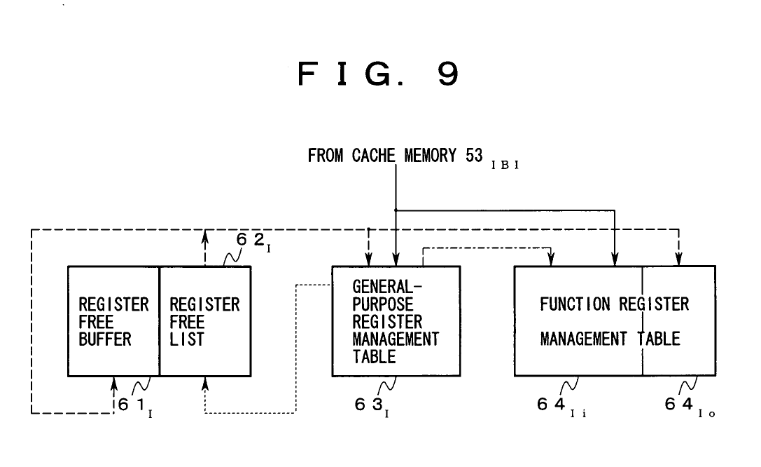

As shown in FIG. 9, the register management section 56_{IBI} is equipped with a register free buffer 61_{I}, a register free list 62_{I}, a general-purpose register management table 63_{I}, and function register management tables 64_{Ii} and 64_{Io}, the details of which are as follows:

(1) The register free buffer 61_{I} is a push-up memory corresponding to each program block (described above), and serves to store a sequence of identifiers of physical registers (hereinafter referred to as “indefinite free registers”) that, among a plurality of physical registers provided in the register file 58_{I}, can be assigned as a certain operand included in an ensuing program block (may not be executed actually under branch prediction) because they are not assigned to the operands of any instructions included in the corresponding program block (may not be executed actually under branch prediction).

(2) The register free list 62_{I} is a push-up memory corresponding to each program block (described above), and serves to store a sequence of identifiers of physical registers (hereinafter referred to as “definite free registers”) that, among the plurality of physical registers provided in the register file 58_{I}, can be assigned as a certain operand included in a program block (may not be executed actually under branch prediction) to be executed subsequently because it is determined that they are not assigned to the operands of any instructions included in the corresponding program block.

(3) The general-purpose register management table 63_{I} is a push-down memory corresponding to each program block (described above), and serves to store a sequence of identifiers of physical registers (hereinafter referred to as “general-purpose physical registers”) that should be applied as individual general-purpose registers in the corresponding program block among the plurality of physical registers provided in the register file 58_{I}.

(4) The function register management tables 64_{II} and 64_{Io} correspond to each program block (described above), are referred to cyclically, are a set of words corresponding to a maximum number of virtual function registers, respectively, that can be correlated provisionally with individual input operands and output operands, and serve to store respective sequences of identifiers of physical registers (hereinafter referred to as “substantive registers”) that are substantively assigned to a sequence of input operands and a sequence of output operands included in the corresponding program block among the plurality of physical registers provided in the register file 58_{I}.

The term “function registers” mean virtual registers that can logically be correlated with operands for each program block and are a set of prescribed numbers of input function registers and output function registers that can be correlated with input operands and output operands, respectively.

Further, the function register management tables 64_{Ii} and 64_{Io} distribute, to the post schedulers 55_{ALU}, 55_{IMU}, and 55_{LSU}, in parallel, an operand status that is a set of pieces of binary information (for the sake of simplicity, it is assumed here that true and false are indicated by respective logical values “1” and “0”) indicating whether or not an identifier of an effective substantive register is stored for each of all the words (correspond to each program block).

Incidentally, after being stored temporarily in the secondary cache 51, the above-mentioned collective machine code sequence is split in a manner described below under the cooperation between the predecoder 52 and the control unit 60 and dispatched to the caches 53_{Imd}, 53_{IBI}, 53_{ALU}, 53_{IMU}, 53_{LSU}, 53_{FPU}, 53_{FBI}, 53_{EImd}, 53_{EXU}, and 53_{EBI}.

The predecoder 52 extracts an operation code of a branch instruction, a sequence of operation codes of only arithmetic instructions, and a sequence of operation codes of only transfer instructions from the sequence of operation codes located at the lowest 7 bits of the respective words of each collective machine code sequence on the basis of the logical values of the separators F, and generates the following branch instruction word, sequence of arithmetic instruction words, and sequence of transfer instruction words:
The branch instruction word is packed with, in order from the MSB, a PB number (may be “0” irrespective of the program block unless the third embodiment (described later) is incorporated) that is given to the program block of the collective machine code sequence concerned and the operation code (or a unique conversion operation code corresponding to the operation code and indicating a type of the branch instruction) of the branch instruction.
The sequence of arithmetic instruction words is packed with, in order from the MSB, the above-mentioned PB number and the operation codes (or unique conversion operation codes corresponding to the operation codes and indicating types of the arithmetic instructions) of the respective arithmetic instructions.
The sequence of transfer instruction words is packed with, in order from the MSB, the above-mentioned PB number and the operation codes (or unique conversion operation codes corresponding to the operation codes and indicating types of the transfer instructions) of the respective transfer instructions.

Further, the predecoder 52 finalizes the branch instruction word, the sequence of arithmetic instruction words, and the sequence of transfer instruction words by performing the following processing on all of the branch instruction word, the arithmetic instruction words, and the transfer instruction words:
Determines the number N_{I} of general-purpose registers (hereinafter referred to simply as “input operands”) in which operation subjects suitable for the operation codes included in each instruction word should be stored in advance, the number Nₒ of general-purpose registers (hereinafter referred to simply as “output operands”) in which operation results should be stored, and the number N_{I} of immediate data (hereinafter referred to as “immediate operands”) that should be given as operation subjects.
Packing, in the branch instruction word, the thus-determined number N_{I} (at this time point, equal to a summation value ΣN_{I} of N_{I}'s in the program block concerned) of input operands (e.g., general-purpose registers for storing not only information indicating the presence/absence and form of a branch condition but also information that should be referred to in calculating or identifying a branch destination address on the main storage) and the thus-determined numbers N_{I} (at this time point, equal to a summation value ΣN_{I} of N_{I}'s in the program block concerned) of immediate operands (indicate a branch destination address etc. on the main storage).
Sequentially packing, in the arithmetic instruction words and the transfer instruction words, summation values ΣN_{I}, ΣNₒ, and ΣN_{I} of the above-mentioned numbers N_{I}'s, Nₒ's, and N_{I}'s of input operands, output operands, and immediate operands in the program block concerned.

In the following description, for the sake of simplicity, an instruction word that is classified as a branch instruction word, an arithmetic instruction word, or a transfer instruction word will be referred to as a function-distinctive instruction word.

The predecoder 52 delivers, to the control unit 60, sequences of the summation values ΣN_{I}'s and ΣNₒ's, determined for the respective program blocks, of the numbers N_{I}'s and Nₒ's that have been determined for the respective instructions included in each program block, as well as the PB numbers indicating the respective program blocks.

Further, once total numbers Σ_{TOTAL}N_{I}, Σ_{TOTAL}Nₒ, and Σ_{TOTAL}N_{I} of input operands, output operands, and immediate operands included in the program block concerned are determined according to the above processing procedure, the predecoder 52 performs the following processing parallel with the above processing:
Splits the operand group of the collective machine code sequence on the basis of the total numbers Σ_{TOTAL}N_{I}, Σ_{TOTAL}Nₒ, and Σ_{TOTAL}N_{I} and control information that is located at the head of the collective machine code sequence concerned, and thereby extracts, from the operand group, a sequence S_{I} of the identifiers of the general-purpose registers corresponding to the input operands, a sequence S_{I} of the values of the immediate operands, and a sequence Sₒ of the identifiers of the general-purpose registers corresponding to the output operands.
Stores the sequence S_{I} of the identifiers of the general-purpose registers corresponding to the input operands and the sequence Sₒ of the identifiers of the general-purpose registers corresponding to the output operands in the cache 53_{IBI}, and stores the sequence S_{I} of the values of the immediate operands in the cache 53_{Imd}.

On the other hand, the register 54_{Imd} sequentially reads the values of the immediate operands (sequence S_{I}) from the cache 53_{Imd} on a program block basis, and distributes, in parallel, all the immediate operands included in the sequence S_{I} to the post schedulers 55_{ALU}, 55_{IMU}, 55_{LSU}, and 55_{FPU}.

The sequence S_{I} of the values of the immediate operands includes an immediate status that is a set of pieces of binary information (for the sake of simplicity, it is assumed that true and false are indicated by respective logical values “1” and “0”) indicating whether the immediate operands arranged in order from the head of the sequence S_{I} are effective or not, as well as fillers that are located at the positions of ineffective immediate operands.

The identifiers of all physical registers as definite free registers (mentioned above) among the physical registers provided in the register file 58_{I} are stored in advance in the register free list 62_{I} of the register management section 56_{IBI} on a program block basis.

The register management section 56_{IBI} performs the following processing on a program block basis:
(1) Refers to the sequences S_{I} and Sₒ of the identifiers of the general-purpose registers corresponding to the input operands and the output operands that are included in a program block and were stored first in the cache 53_{IBI}.

(2) Physical registers are assigned to the general-purpose registers that are indicated by the respective identifiers included in the identifier sequence Sₒ and correspond to the output operands, according to the following rules:

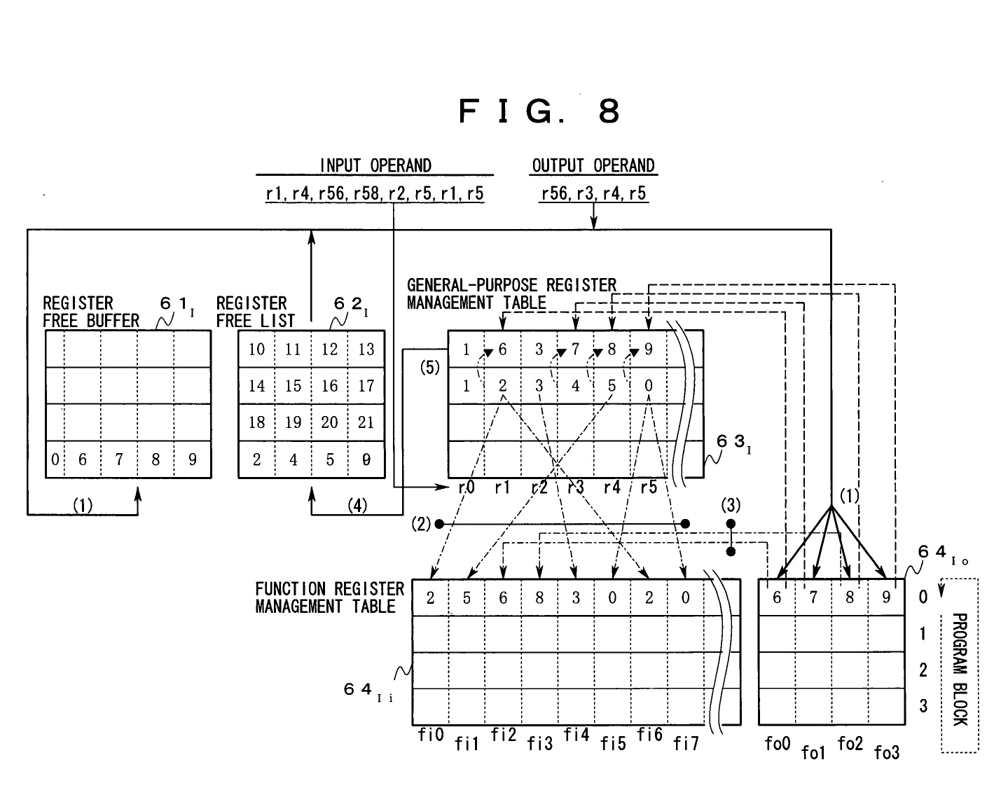

2-1) The identifiers of respective definite free registers that are stored in the register free list 62_{I} are moved to the register free buffer 61_{I} and adjoining ones of the fields of a record of the function register management table 64_{Io} corresponding to the program block concerned, the number of the adjoining fields being equal to the number (may be “0”) of identifiers included in the sequence Sₒ of identifiers (indicated by symbol (1) in FIG. 8).

2-2) A predetermined dummy physical register number (for the sake of simplicity, assumed here to be “0”) is stored in the remaining fields.

(3) Physical registers are assigned to the general-purpose registers that are indicated by the respective identifiers included in the identifier sequence S_{I} and correspond to the input operands, according to the following rules:

3-1) It is judged whether or not the identifier concerned is greater than or equal to 56 which signifies that the identifier corresponds to one of the above-mentioned particular general-purpose registers.

3-2) If the judgment result is false, the identifier of a general-purpose register that is stored in a field of the general-purpose register table 63_{I} corresponding to the identifier concerned (which means that it was assigned to a general-purpose register common to a preceding program block) is copied to a field (hereinafter referred to as “input function register field”) of a record of the function register management table 64_{Ii} corresponding to the program block concerned, the field being located at the same position in the record as the position of the identifier concerned in the identifier sequence S_{I} (indicated by symbol (2) in FIG. 8)

3-3) if the judgment result is true, the number of a physical register that is stored in a field that is located at a position corresponding to the difference between the identifier concerned and “56” in the record of the function register management table 64_{Io} corresponding to the same program block (which means that it is assigned to an output operand of other instruction included in the common program block) is copied (indicated by symbol (3) in FIG. 8).

3-4) In spite of the above judgment result, the above dummy physical register number is stored in the remaining field of the corresponding general-purpose register table 63_{I}.

(4) The identifiers of the above general-purpose physical registers are stored in the register free list 62_{I} (indicated by symbol (4) in FIG. 8).

(5) A word obtained by replacing the identifiers of the above general-purpose physical registers with the identifiers of the above-mentioned definite free registers (indicated by symbol (4) in FIG. 8) is stored in the general-purpose register management table 63_{I}, whereby the general-purpose register management table 63_{I} is updated.

The post schedulers 55_{ALU}, 55_{IMU}, and 55_{LSU} perform, in parallel, in the following manner, processing that is suitable for the individual function-distinctive instruction words included in the branch instruction word, the sequence of arithmetic instruction words, and the sequence of transfer instruction words that were generated by the predecoder 52 in the above-described manner and are stored in the caches 53_{ALU}, 53_{IMU}, and 53_{LSU}.

In the following description, the operations of the post schedulers 55_{ALU}, 55_{IMU}, and 55_{LSU} and the caches 53_{ALU}, 53_{IMU}, and 53_{LSU} will be described by using a suffix “p” instead of the suffixes “ALU,” “IMU,” and “LSU,” which means that these operations are the same and are performed parallel.

The summation values ΣN_{I} and ΣNₒ that are packed in each function-distinctive instruction word mean input operands and output operands, respectively, that should be referred to for each program block by the function unit 57ₚ that realizes the function suitable for the function-distinctive instruction word, and also mean fields corresponding to those input operands and output operands among the fields of the corresponding records of the function register management tables 64_{Ii} and 64_{Io}.

The summation value ΣN_{I} that is packed in each function-distinctive instruction word means the identifiers of immediate operands that should be referred to first for each program block by the function unit 57ₚ that realizes the function suitable for the function-distinctive instruction word.

The post scheduler 55ₚ performs the following processing by referring to, on a program block basis, the function-distinctive instruction words stored in the cache 53ₚ:

(1) Identifies the numbers N_{I} and N_{I} of input operands and immediate operands that should be referred to during processing that should be performed by the function unit 57ₚ in accordance with the manipulation node that is packed in the function-distinctive instruction word concerned, as well as the number Nₒ of output operands that should be generated as a result of the processing.

(2) Refers to the summation values ΣN_{I}, ΣNₒ, and ΣN_{I} that are packed in the function-distinctive instruction word concerned, and judges whether or not all the following logical values are equal to “1” (which means that all the operands are definite):
The logical values of ΣN_{I}th and following N_{I} bits of the above-mentioned operand status.
The logical values of ΣNₒth and following Nₒ bits of the operand status.
The logical values of ΣN_{I}th and following N_{I} bits of the above-mentioned immediate status.

(3) If the judgment result is false, suspends the processing that relates to the function-distinctive instruction word concerned.

(4) If the judgment result is true, delivers, to the function unit 57ₚ, an instruction consisting of the following identifiers and immediate operands and the manipulation instruction that is packed in the function-distinctive instruction word concerned.
The identifiers of N_{I} substantive registers (meaning physical registers assigned to the input operands) that are stored in ΣN_{I}th and following fields of the function register management table 64_{Ii}.
The identifiers of Nₒ substantive registers (meaning physical registers assigned to the output operands) that are stored in ΣNₒth and following fields of the function register management table 64_{Io}.
ΣN_{I}th and following N_{I} immediate operands (referred to as input operands) of the above-mentioned sequence S_{I} of the values of the immediate operands.

In response to the instruction that is delivered from the post scheduler 55ₚ in the above manner, the function unit 57ₚ performs processing suitable for the instruction according to the following rules:
Refers to, as input operands, the contents of the individual substantive registers indicated by the above-mentioned N_{I} identifiers among the physical registers provided in the register file 58_{I} and the values of the above-mentioned N_{I} immediate operands.
Stores output operands in the respective substantive registers indicated by the above-mentioned Nₒ identifiers among the physical registers provided in the register file 58_{I}.

That is, all the instructions included in each program block are classified into groups corresponding to the respective function units and instructions each of which consists of an operation code and summation values ΣN_{I}, ΣNₒ, and ΣN_{I} are delivered to the function units. The function units operate parallel using the input operands and output operands that are identified as desired numbers of substantive registers that are stored in the ΣN_{I}th and the following fields and the ΣNₒth and the following fields of the function register management tables 64_{Ii} and 64_{Io} and a desired number of, ΣN_{I}th and following immediate operands of the sequence S_{I} of the values of the immediate operands.

During the pieces of processing indicated by symbols (1)-(5) in FIG. 8, as for individual function registers, free physical registers are assigned to operands as appropriate via the function register management tables 64_{Ii} and 64_{Io} for each program block in such a manner that both of dependence relationships inside the program block concerned and dependence relationships with the preceding program block and the ensuing program block.

In this embodiment, not only can a machine code that is different in format from the machine codes shown in FIG. 7 be used parallel with the latter machine codes in accordance with the logical value of the above-mentioned spare bit E, but also, for example, the function unit 57_{FPU} (57_{EXU}) that can correspond to such a machine code having a different format or a desired operation code that is added together with a separator F and the caches 53_{FPU} and 53_{FBI}, post scheduler 55_{FPU}, and register management section 56_{FBI} (the caches 53_{EImd}, 53_{EXU}, and 53_{EBI}, register 54_{EImd}, post scheduler 55_{EXU}, register management section 56_{EBI}, and register file 58_{E}) that correspond to the function unit 57_{FPU} (57_{EXU}) can be added easily (indicated by broken lines in FIG. 5).

The cooperation between the function unit 57_{FPU} (57_{EXU}) and the caches 53_{FPU} and 53_{FBI}, post scheduler 55_{FPU}, and register management section 56_{FBI} (the caches 53_{EImd}, 53_{EXU}, and 53_{EBI}, register 54_{EImd}, post scheduler 55_{EXU}, register management section 56_{EBI}, and register file 58_{E}) in the case where an instruction or a function unit is added in the above manner is the same as the above-described cooperation between the function unit 57ₚ and the caches 53_{Imd} and 53ₚ, register 54_{Imd}, post scheduler 55ₚ, and register management section 56_{IBI}, and hence will not be described.

In this embodiment, in contrast to the conventional examples, although machine codes are formed without including redundant information, the formats of the machine codes can be altered flexibly and it is not necessary to newly save the information of internal components before activation of interrupt processing.

Therefore, as itemized below, this embodiment enables flexible addition and alteration of functions without impairing the advantages of the RISC architecture:
A high degree of freedom relating to the execution latency of extendable instructions is secured.
The alteration of the basic structure and operation of a pipeline is facilitated.
A variety of instructions such as a transfer instruction and a branch instruction can be added easily.
The number of operands (including immediate operands) and their word length can be changed easily for each instruction.
This embodiment well matches such techniques as the superscalar, branch prediction, and out of order, and hence the processing speed can be increased easily by using these techniques.
The efficiency of utilization of the storage areas of the main storage can be increased.
Interrupt processing can be activated more quickly without complicating the hardware configuration.

In this embodiment, immediate operands that should be supplied to the function unit 57ₚ are delivered to it as appropriate via the cache 53_{Imd} and the register 54_{Imd}.

However, the invention is not limited to such a configuration. For example, those immediate operands may be delivered to the function unit 57ₚ in either of the following forms:
Packed in part of the function-distinctive instruction words by the predecoder 52 and delivered to the function unit 57ₚ via the cache 53ₚ and the post scheduler 55ₚ.
Stored in one definite free register of the physical registers and delivered to the function unit 57ₚ as the identifier of the definite free register.

In this embodiment, the dependence relationship with the preceding program block is assured because physical registers assigned to general-purpose registers are handed over to the ensuing program block.

However, the invention is not limited to such a configuration. Where reduction in throughput (response speed) is permitted, a configuration is possible in which physical registers assigned to general-purpose registers are updated for each program block according to a desired algorithm and information to be stored in a general-purpose register that is assigned a different physical register is transferred (copied) as appropriate from a physical register that was assigned to the general-purpose register previously.

In this embodiment, physical registers that are assigned to output function registers (mentioned above) are updated for each program block and the output operands of a series of instructions included in each program block are stored in the thus-assigned physical registers as appropriate.

However, the invention is not limited to such a configuration. For example, a configuration is possible in which such output operands are stored in common physical registers assigned to all program blocks, and saved as appropriate before execution of a series of instructions included in the ensuing program block or transferred to proper physical registers enabling assurance of the dependence relationship.

In this embodiment, the operation codes that are separated by the separators F so as to correspond to individual function units are located at the lowest portions of the words that are included in the collective machine code sequences PB1 and PB2 shown in FIG. 7.

However, the invention is not limited to such a configuration. The separators F may be omitted in the case where it is permitted that a unique operation code that is given irrespective of a corresponding function unit is incorporated in each of the words constituting the machine code sequences PB1 and PB2.

In this embodiment, summation values ΣN_{I}, ΣNₒ, and ΣN_{I} of the numbers of input operands, output operands, and immediate operands of individual instructions included in each program block are determined independently by the predecoder 52.

However, the invention is not limited to such a configuration. For example, the processing that is performed by the predecoder 52 to determine summation values ΣN_{I}, ΣNₒ, and ΣN_{I} may be simplified by a measure that the numbers N_{I}, Nₒ and N_{I} of input operands, output operands, and immediate operands of the instruction are packed in the lowest 7 bits of each word shown in FIG. 7 and an operation code is set as an immediate operand of the instruction.

In this embodiment, the logical value of the separator F is set at “1” only if the separator F is added to the first operation code corresponding to the function units 57_{ALU}, 57_{IMU}, and 57_{LSU} among the operation codes included in each collective machine code sequence.

However, the separators F may be replaced by either of unique identifiers indicating corresponding function units and single bits whose logical value is inverted every time the function unit corresponding to the operation code included in the word varies, as long as it is permitted within the confines of the word length of the individual words included in each collective machine code sequence.

In the invention, a word corresponding to a branch instruction is located at the tail of each collective machine code sequence. However, a word corresponding to a branch instruction may be located at any position in each collective machine code sequence as long as the order of execution of instructions including the branch instruction is kept proper for each program block.

Further, in this embodiment, the invention is applied to a computer having a RISC architecture in which instructions have the constant word length. However, the application field of the invention is not limited to such computers. For example, the invention can similarly be applied to computers that employ a variable-word-length instruction system.

### Embodiment 2

The operation of the second embodiment of the invention will be described below with reference to FIG. 5.

The control unit 60 recognizes, as the following values, the values of pointers WP_{ALU}, WP_{IMU}, and WP_{LSU} that indicate storage areas to which the first branch instruction word, arithmetic instruction word, and transfer instruction word included in each program block should be written among the storage areas of the caches 53_{ALU}, 53_{IMU}, and 53_{LSU} and the value of a pointer MP that indicates a storage area of the main storage where the collective machine code sequence of each program block is stored:
WP_{ALU}: The head address of storage areas of the cache 53_{ALU} to which instruction words have been written by the predecoder 52.
WP_{IMU}: A summation value of the numbers of branch instruction words that have been written to the cache 53_{IMU} by the predecoder 52 minus a summation value of the numbers of branch instruction words that have been executed by the function unit 57_{IMU} under the post scheduler 55_{IMU} among those branch instruction words.
WP_{LSU}: A summation value of the numbers of transfer instruction words that have been written to the cache 53_{LSU} by the predecoder 52 minus a summation value of the numbers of transfer instruction words that have been executed by the function unit 57_{LSU} under the post scheduler 55_{LSU} among those transfer instruction words.
MP: The address of a storage area, among the storage areas of the main storage, where the head word of each of collective machine code sequences read out on a program block basis by the predecoder 52 via the secondary cache 51 is stored.

The form of processing that should be performed by the predecoder 52 and the control unit 60 to enable recognition of the values of the pointers WP_{ALU}, WP_{IMU}, WP_{LSU}, and MP may be one of a variety of forms depending on the addressing of the caches 53_{ALU}, 53_{IMU}, and 53_{LSU} etc. and is not an important feature of the invention, and hence will not be described in detail.

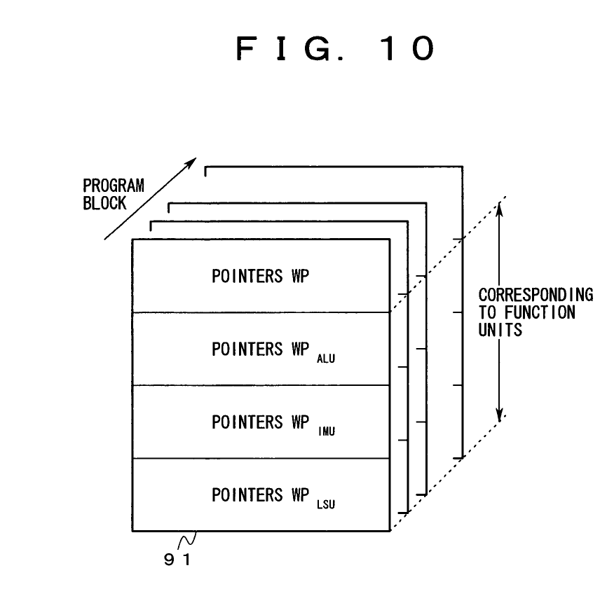

The control unit 60 correlates, as appropriate, sets of values of the pointers WP_{ALU}, WP_{IMU}, WP_{LSU}, and MP with respective program blocks for a maximum number of program blocks that can be stored in the caches 53_{ALU}, 53_{IMU}, and 53_{LSU} as sets of arithmetic instruction words, branch instruction words, and transfer instruction words, and registers those sets in, for example, a PB table 91 shown in FIG. 10.

With a valid branch, the function unit 57_{IMU} delivers, to the control unit 60, the value of the pointer MP that indicates a branch destination on the main storage.

The control unit 60 judges whether or not that the pointer MP is registered in the PB table 91. Only if the judgment result is true, the control unit 60 delivers, to the post schedulers 55_{ALU}, 55_{IMU}, and 55_{LSU}, the values of the pointers WP_{ALU}, WP_{IMU}, and WP_{LSU} that are registered in the PB table 91 as corresponding to the pointer MP.

After executing function-distinctive instruction words that should be executed before the above branch, the post schedulers 55_{ALU}, 55_{IMU}, and 55_{LSU} recognize, as a new program block, a sequence of arithmetic instruction words, a sequence of branch instruction words, and a sequence of transfer instruction words that are stored in storage areas indicated by the pointers WP_{ALU}, WP_{IMU}, and WP_{LSU} among the storage areas of the caches 53_{ALU}, 53_{IMU}, and 53_{LSU}.

The operations that are performed by the caches 53_{Imd} and 53_{IBI}, the register 54_{Imd}, and the register management section 56_{IBI} during execution of the thus-recognized program block are basically the same as in the first embodiment, and hence will not be described.

Therefore, according to this embodiment, sequences of function-distinctive instruction words that are already stored in the cache 53ₚ can be referred to effectively in connection with a branch, whereby the total efficiency of processing can be increased.

### Embodiment 3

The third embodiment of the invention will be described below with reference to FIG. 5.

This embodiment is characterized in the following procedure of processing that is performed by the post scheduler 55ₚ.

The post scheduler 55ₚ sequentially writes, to the cache 53ₚ, function-distinctive instruction words in which all operands that are necessary for execution by the function unit 57ₚ are determined.

In the following description, for the sake of simplicity, the function-distinctive instruction words that have been written sequentially in this manner will be referred to as “re-stored function-distinctive instruction words.”

Further, if it is recognized under the control of the post scheduler 55_{IMU} (or under the cooperation between the post scheduler 55_{IMU} and the function unit 57_{IMU}) that the program block concerned should be executed repeatedly without branching to another program block, the post scheduler 55ₚ re-executes the sequence of re-stored function-distinctive instruction words while reading the PB number packed in the re-stored function-distinctive instruction words as another PB number (e.g., given as the sum of the former PB number and a predetermined constant).

Such a sequence of re-stored function-distinctive instruction words is obtained in advance by rearranging function-distinctive instruction words in such order that they are rendered actually executable.

Therefore, according to this embodiment, during repetitive execution of the same program block, instructions that are rendered executable earlier are executed with higher priority.

### Embodiment 4

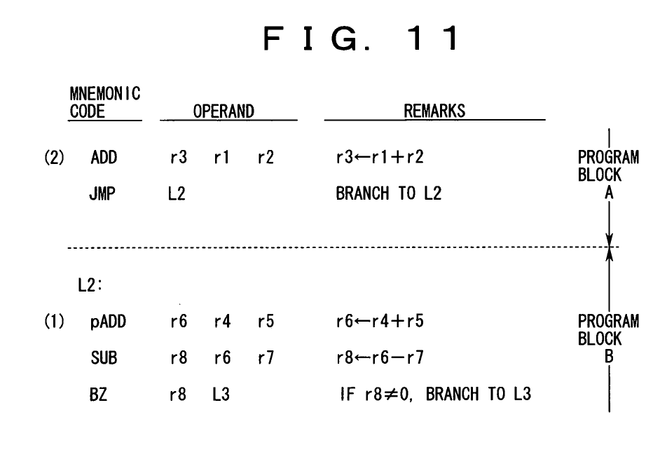

FIG. 11 illustrates the operation of the fourth embodiment of the invention. The operation of the fourth embodiment of the invention will be described below with reference to FIGS. 5 and 11.

In this embodiment, a priority addition instruction “pADD” that should be executed with higher priority than arithmetic instructions such as an addition instruction “ADD” that are included in the preceding program block is added as an arithmetic instruction that should be realized by the function unit 57_{ALU}.

For example, as indicated by symbol (1) in FIG. 11, such a priority addition instruction pADD is included in a program block B that should be executed subsequently to a program block A in which an addition instruction “ADD” is included.

Even if the current situation is such that the arithmetic instructions included in the program block A should be executed, the post scheduler 55_{ALU} judges whether the following conditions are satisfied by cooperating with the control unit 60 and the register management section 56_{IBI}:
All the arithmetic instructions (hereinafter referred to as “ensuing arithmetic instructions”) included in the ensuing program block B are already stored in the cache 53_{ALU}.
The assignment of physical registers to all the operands of the ensuing arithmetic instructions has already completed.

If the judgment result is true, the post scheduler 55_{ALU} judges whether or not the ensuing arithmetic instructions include a priority addition instruction pADD.

If the judgment result is true, the post scheduler 55_{ALU} selects the priority addition instruction pADD with highest priority given to it and requests the function unit 57_{ALU} to execute the priority addition instruction pADD.

It is assumed that the function unit 57_{ALU} has (or is newly given), in advance, a function that enables execution of the priority addition instruction pADD, and that the assignment of physical registers to the input operands and output operands of the program block B is performed early by a pipeline method even before execution of the program A is completed.

More specifically, as indicated by symbol (2) in FIG. 11, the priority addition instruction pADD included in the program block B is executed with higher priority than the addition instruction ADD that has no dependence relationships with any instructions included in the program block B though it is included in the program block A.

Therefore, according to this embodiment, adding, to the first embodiment, the priority addition instruction pADD that realizes a new function enables early assurance of a dependence relationship (register r6→r8) between a subtraction instruction “SUB” that follows the priority addition instruction pADD in the program block B and a branch instruction “BZ” that follows the subtraction instruction SUB.

### Embodiment 5

The operation of the fifth embodiment of the invention will be described below with reference to FIG. 5.

This embodiment is provided with not only the above-described function unit 57_{EXU} but also the caches 53_{EImd}, 53_{EXU}, and 53_{EBI}, register 54_{EImd}, post scheduler 55_{EXU}, register management section 56_{EBI}, and register file 58_{E} that cooperate with the function unit 57_{EXU}.

The function unit 57_{EXU} has a function of identifying, as an output operand, timing with which a prescribed transfer instruction should be executed by the function unit 57_{LSU}, for example, or a transfer destination, transfer source, or transfer subject of the transfer instruction.

The function units 57_{LSU} and 57_{EXU} perform individual pieces of processing when receiving individual transfer instruction words or a common transfer instruction word indicating an instruction that should be executed under cooperation between the function units 57_{LSU} and 57_{EXU}.

However, the function unit 57_{LSU} suspends execution or a start of execution of the transfer instruction word concerned until receiving an output operand (one of timing, a transfer destination, a transfer source, and a transfer subject (mentioned above)) that should be identified by and supplied from the function unit 57_{EXU}.

As described above, according to this embodiment, an instruction that realizes a desired function under cooperation among a plurality of function units can be added or altered flexibly. Where one of the plurality of function units is an existing function unit, the functions of the existing function unit is prevented from being complicated or altered unduly.

### Embodiment 6

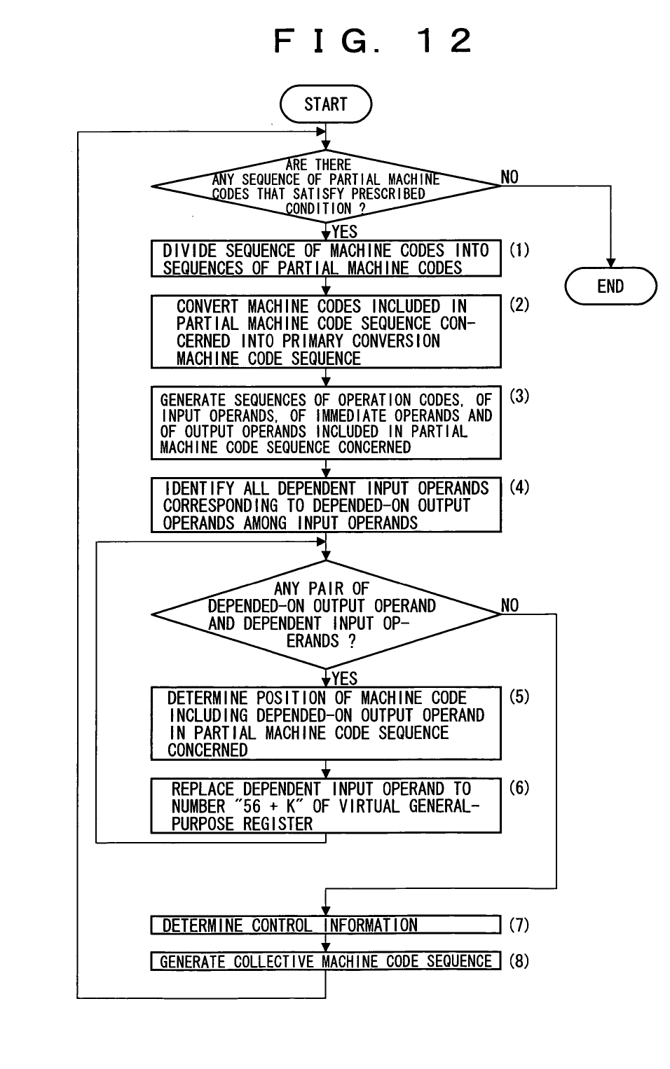

FIG. 12 is a flowchart showing the operation of a sixth embodiment of the invention.

The operation of the sixth embodiment of the invention will be described below with reference to FIGS. 6A-6C, 7 and 12.

This embodiment is characterized in the procedure of processing that realizes the following program conversion.

In this embodiment, as shown in FIG. 6B, a sequence of machine codes that is based on a three-address scheme and has been generated by assembling a source code that is written in an assembler language that complies with the RISC architecture is given as a subject of program conversion.

Such a sequence of machine codes is processed according to the following procedure:

(1) A maximum number N_{MAX} of instructions that are allowed to be included in a single program block in a computer that is involved in one of the first to fifth embodiments is given, and the sequence of machine codes is divided into partial machine code sequences that satisfy all the following conditions (step (1) in FIG. 12).
No branch instruction is included or a single branch instruction is included.
Where a branch instruction is included, a branch destination of the branch instruction is not included in the partial machine code sequence to which the branch instruction belongs.
The number of included machine codes is less than the maximum number N_{MAX}.

(2) The following processing is performed on every partial machine code sequences:

2-1) The individual machine codes included in the partial machine code sequence concerned are converted into sequences (hereinafter referred to as “primary conversion machine code sequences”) of machine codes corresponding to branch instructions, arithmetic instructions, (floating point arithmetic instructions and extended instructions), and transfer instructions, respectively (step (2) in FIG. 12).

2-2) A sequence of operation codes (hereinafter referred to as “operation code sequence”), a sequence of input operands (hereinafter referred to as “input operand sequence”), a sequence of immediate operands (hereinafter referred to as “immediate operand sequence”), and a sequence of output operands (hereinafter referred to as “output operand sequence”) are generated from each primary conversion machine code sequence (step (3) in FIG. 12).

2-3) Among the input operands included in the input operand sequence, all input operands (hereinafter referred to as “dependent input operands”) corresponding to output operands (hereinafter referred to as “depended-on output operands”) of machine codes that are included in the output operand sequence and precede the machine codes concerned are identified (indicated by symbol (4) in FIG. 12).

2-4) The following processing is performed on all of the thus-identified depended-on output operands and dependent input operands.
A position K (≧0), in the partial machine code sequence concerned, of each machine code including a depended-on output operand among the machine codes included in the partial machine code sequence concerned is determined (step (5) in FIG. 12).
Each dependent input operand is replaced with a number of a virtual general-purpose register that is indicated by “56+K” (step (6) in FIG. 12).

2-5) Control information (described above) is determined on the basis of the structure etc. of the operation code sequence, the input operand sequence, the immediate operand sequence, and the output operand sequence (step (7) in FIG. 12).

2-6) A collective machine code sequence as shown in FIG. 7 is generated as a sequence of words that complies with the following format (step (8) in FIG. 12):
Each operation code included in the operation code sequence and a separator F (described above) are located the lowest 8 bits of each word.
The control information is packed in the high portion of the head word.
An operand group consisting of the input operand sequence, the immediate operand sequence, and the output operand sequence are packed in the high portions of the second and following words (dummy physical register numbers (mentioned above) are placed in surplus fields as appropriate).

As described above, in this embodiment, a sequence of machine codes that can be executed by a desired processor that is compatible with the RISC architecture is converted to machine codes that are executable by a computer according to one of the first to fifth embodiments.

The term “executable” signifies not only a state that all conditions necessary for the execution of machine codes concerned are satisfied but also a state that those conditions can be regarded as satisfied during execution or a state that the sequence of machine codes is/was regarded as a subject of execution.

Therefore, an existing load module can be used as an effective one quickly and efficiently without the need for referring to a source code.

In this embodiment, an existing load module (i.e., sequence of machine codes) is directly converted into a load module that is executable by a computer according to the invention. However, a load module that is executable by such a computer may be generated by directly converting, in the symbol domain, and assembling a source code written in a desired assembler language.

In this embodiment, a source code is converted to machine codes having the format of FIG. 7. However, the invention is not limited to such a configuration. For example, a source code may be decomposed directly into bus instructions and operation codes (described above) and stored in corresponding cache memories as appropriate like data obtained as a result of predecoding.

In each of the above embodiments, collective machine code sequences corresponding to respective program blocks are generated as a sequence of three-address-type machine codes. However, the invention is not limited to the case of the three-address scheme, and can also be applied to not only processors that are compatible with the two-address-type, one-address-type, or zero-address-type instruction format but also processors that are compatible with a combination of those schemes.

In each of the above embodiments, the invention is applied to a processor that is configured according to the RISC architecture. However, the invention is not limited to the case of being applied to such a processor and can similarly be applied to processors that are configured according to the CISC architecture.

In each of the above embodiments, the invention is applied to a general purpose processor. However, the invention is not limited to the case of being applied to such a processor. For example, the invention can similarly be applied to dedicated processors such as DSPs that are used for speech processing, image processing, etc.

In each of the above embodiments, one cache memory corresponds to each function unit. However, the invention is not limited to such a configuration. For example, as long as a proper pair or combination can be identified on the basis of an operation code or the like, a single or plurality of function units may be correlated with a plurality of cache memories and a plurality of function units may be correlated with a single or plurality of cache memories.

Although, the basic block is not defined in each of the above embodiments, the basic block may not always include a branch instruction as long as its entrance and exit are only the head and tail instructions, respectively.

For example, where the entrance of a basic block is not necessarily definite because a source code corresponding to a load module is not written in a structure language and is not in module form at all, the entrance may be identified by predicting it dynamically.

The invention is not limited to the above embodiments and various modifications may be made without departing from the spirit and scope of the invention. Any improvement may be made in part or all of the components.

1. An instruction control apparatus comprising:
an operands summation section extracting, from each of basic blocks, input operands and output operands of all of instructions included therein, and individually creating sequences of summation values of numbers of input operands and of output operands, the basic blocks each being made up of a sequence of machine codes;
a virtual assigning section managing virtual input registers and output registers which are assigned to input operands and output operands in each of the basic blocks, and correlating the input operands and the output operands with input registers and output registers without overlap, respectively, the input and output registers being ones in ranks lower than corresponding summation values included in the sequences of summation values, the assignment being updated for each of the basic blocks; and
an operand delivering section managing physical registers used for delivery of information to/from function units, and assigning the physical registers to each of sets of output registers and of input registers, the function units having function of executing instructions that can be included in the basic blocks, the output registers being correlated with respective output operands of all of the instructions, the input registers being correlated with input operands which are to be delivered to the function units as respective input operands.

2. The instruction control apparatus according to claim 1, wherein:
said operands summation section does not count a number of immediate operands for a number of input operands included in each of the summation values; and
said operand delivering section delivers to said function units the immediate operands which said operands summation section has not counted.

3. The instruction control apparatus according to claim 1, wherein:
said operands summation section individually generates, for each of the basic blocks, summation values of numbers of immediate operands and of other input operands; and
said operand delivering section individually assigns physical registers to the immediate operands and the other input operands to store the immediate operands in respective physical registers assigned thereto.

4. The instruction control apparatus according to claim 1, wherein
said virtual assigning section maintains existing correlations of input registers and output registers with input operands and output operands of instructions included in an immediately preceding basic block among the operands included in the sequences of input operands and of output operands.

5. The instruction control apparatus according to claim 1, wherein:
particular ones of said physical registers are correlated in advance with an output operand of each instruction included in the basic blocks; and
said operand delivering section preferentially assigns certain physical registers of the particular physical registers to an output register that is correlated with an output operand of each instruction included in each of the sets and to an input register which is to be given the output operand, certain physical registers being correlated in advance with the output operand.

6. The instruction control apparatus according to claim 1, wherein
said operand delivering section maintains existing assignments of physical registers to input operands having no dependence relationships within the basic blocks among input operands of instructions included in the basic blocks.

7. The instruction control apparatus according to claim 1, wherein:
said virtual assigning section stores, in a cache memory that corresponds to one of the function units having a function of executing each instruction included in the basic blocks, a record including an operation code of the instruction and reference addresses of input registers and an output register that are correlated with input operands and an output operand of the instruction, respectively; and
said operand delivering section assigns the physical registers to each set of input registers and output registers that are uniquely determined by reference addresses included in most previous records stored in cache memories corresponding to the function units and correlated with input operands and output operands of such a number as to be necessary for execution of instructions corresponding to the most previous records.

8. The instruction control apparatus according to claim 7, further comprising
branch destination tables storing therein cache addresses and addresses of storage areas of a main storage for each of the basic blocks, the cache addresses designating storage areas storing therein instructions with operation codes that are stored first in the cache memories, the storage areas of a main storage individually storing therein the instructions with the first stored operation codes, wherein
when a particular one of said function units performs a valid branch, said operand delivering section updates read pointers of the cache memories to a cache address that is stored in said branch destination tables in association with an address indicating a destination of the branch.

9. The instruction control apparatus according to claim 1, wherein
each of the basic blocks is a sequence of words that correspond to function units having functions of executing instructions that can be included in the sequence of machine codes, and each of the basic blocks is composed of a sequence of words formed by packing all or part of operation codes, input operands, and output operands of instructions included in the sequence of machine codes.

10. The instruction control apparatus according to claim 9, wherein
a particular instruction that can be included in the sequence of machine codes includes an operation code as an immediate operand and is formed by replacing the operation code with a combination of numbers of input operands and output operands.

11. The instruction control apparatus according to claim 9, wherein
the operation codes are packed with identifiers of their respective function units or information signifying coincidence/non-coincidence between the respective function units and previously used function units.

12. The instruction control apparatus according to claim 9, wherein
the operation codes are words whose values can be identical, when corresponding to different function units.

13. The instruction control apparatus according to claim 9, wherein
all or part of an operation code, an input operand, and an output operand of a branch instruction are included in each of the basic blocks, being packed at a head or a tail of the basic block.

14. The instruction control apparatus according to claim 1, wherein
each of the basic blocks is a sequence of words having a constant word length.

15. The instruction control apparatus according to claim 8, wherein
each of the basic blocks is a sequence of words with a constant word length.

16. The instruction control apparatus according to claim 9, wherein
each of the basic blocks is a sequence of words with a constant word length.

17. The instruction control apparatus according to claim 1, wherein
part of said physical registers is/are general-purpose register(s).

18. The instruction control apparatus according to claim 8, wherein
part of said physical registers is/are general-purpose register(s).

19. The instruction control apparatus according to claim 9, wherein
part of said physical registers is/are general-purpose register(s).

20. A function unit comprising:
a scheduler selecting an executable instruction from instructions that each include an operation code and operands indicated as identifiers of virtual registers and that are stored in a cache memory together with basic block numbers identified under an instruction prefetch scheme, the executable instruction being stored in the cache memory together with a basic block number to be executed under an instruction control; and
a processing section acquiring, from the cache memory, the instruction selected by said scheduler, and performing processing suitable for operation codes of the selected instruction while converting an identifier to a physical register under the instruction control, the identifier indicating an operand of the selected instruction, wherein
said scheduler stores, in the cache memory, the selected instruction and a basic block number to which the selected instruction belong, and fixes the basic block number in repeatedly executing the basic block.

21. A function unit comprising:
a scheduler selecting an executable instruction from instructions that each include an operation code and operands indicated as identifiers of virtual registers and that are stored in a cache memory together with basic block numbers identified under an instruction prefetch scheme, the executable instruction being stored in the cache memory together with a basic block number to be executed under an instruction control; and
a processing section acquiring, from the cache memory, the instruction selected by said scheduler, and performing processing suitable for operation codes of the selected instruction while converting an identifier to a physical register under the instruction control, the identifier indicating an operand of the selected instruction, wherein
said scheduler preferentially selects an instruction having a particular operation code from executable instructions.

22. A function unit comprising:
a scheduler selecting an executable instruction from instructions that each include an operation code and operands indicated as identifiers of virtual registers and that are stored in a cache memory together with basic block numbers identified under an instruction prefetch scheme, the executable instruction being stored in the cache memory together with a basic block number to be executed under an instruction control; and
a processing section acquiring, from the cache memory, the instruction selected by said scheduler, and performing processing suitable for operation codes of the selected instruction while converting an identifier to a physical register under the instruction control, the identifier indicating an operand of the selected instruction, wherein
said scheduler selects an instruction having a particular operation code from the instructions stored in the cache memory when given an immediate operand of the instruction or information from exterior or having successfully delivered the immediate operand or the information to exterior, the information having a prescribed correlation with the immediate operand of the instruction.

23. A program conversion apparatus comprising:
a machine code decomposing section dividing a sequence of machine codes into a sequence of basic blocks, and extracting, from each of the basic blocks, input operands, output operands and operation codes of all instructions included therein;
an instruction sorting section sorting the operation codes of each of the basic blocks extracted by said machine code decomposing section into groups of operation codes in order for respective function units to perform processing suitable for the groups of operation codes; and
a converting section converting the sequence of machine codes into sequences of words in a form suitable for an instruction control, the sequences of words in which the input and output operands extracted by said machine code decomposing section and the operation codes obtained by sorting by said instruction sorting section are packed in each of the basic blocks in order of the function units.

24. A language processing apparatus comprising:
a source program decomposing section dividing a sequence of instructions into sequences of basic blocks, and extracting, from each of the basic blocks, identifiers of input operands and output operands of all instructions included therein as well as mnemonic codes of the instructions, the sequence of instructions being written in an assembler language and not assembler instructions;
an instruction sorting section sorting the mnemonic codes of each of the basic blocks extracted by said source program decomposing section into groups of mnemonic codes in order for respective function units to perform processing suitable for the groups; and
a converting section converting the sequence of instructions to sequences of machine codes in a form suitable for an instruction control over the sequence of instructions, the sequences of machine codes in which input and output operands and operation codes corresponding to the identifiers extracted by said source program decomposing section and corresponding to the mnemonic codes obtained by sorting by said instruction sorting section are packed in each of the basic blocks in order of the function units.
